(19) United States
(12) Patent Application Publication
(10) Pub. No.: US 2018/0376248 A1
(43) Pub. Date: Dec. 27, 2018

(54) Micro Loudspeaker

(71) Applicant: Acoustic Innovation (Huizhou) Co., Ltd, Huizhou (CN)

(72) Inventors: Chee Kit Yuen, Huizhou, Guangdong (CN); Lei Zheng, Huizhou, Guangdong (CN); Yuanyuan Li, Huizhou, Guangdong (CN)

(21) Appl. No.: 16/046,989

(22) Filed: Jul. 26, 2018

Related U.S. Application Data
(63) Continuation of application No. PCT/CN2017/071658, filed on Jan. 19, 2017.

(51) Int. Cl. H04R 9/06; H04R 9/02; H04R 7/12; H04R 1/28

(52) U.S. Cl. CPC H04R 9/06; H04R 9/025; H04R 2201/02; H04R 1/2826; H04R 7/127

(57) ABSTRACT

A micro loudspeaker includes a frame with open top, T-yoke, magnet, washer, diaphragm, voice coil, protective cap and circuit board. The diaphragm includes a dome portion and a corrugated rim portion connected to the dome portion in a circumferential direction of the dome portion. Profiles of cross sections of the dome portion and the corrugated rim portion are each a multi-segment arc. A ring-shaped step for connecting the diaphragm is formed on an inner wall of the frame and above the washer. A height difference between the ring-shaped step and the washer ranges from 0.1 mm to 0.8 mm. The bottom of an edge of the corrugated rim portion is connected to a top surface of the ring-shaped step. The cap is placed over the diaphragm, and is provided with a through hole having a diameter ranging from 1-3 mm at the center opposite to the dome portion.

### CROSS REFERENCE TO RELATED APPLICATIONS

The present application is a Continuation Application of PCT Application No. PCT/CN2017/071658 filed on Jan. 19, 2017. All the above are hereby incorporated by reference.

### FIELD

The present application relates to the technical field of electro-acoustic conversion, and in particular to a micro loudspeaker.

### BACKGROUND

It is well known that a loudspeaker is used for sounding.

However, currently existing loudspeakers can neither achieve symmetric double peak high sound pressure output frequency response within specified frequencies 2500±500 Hz and 8000±500 Hz nor ensure that its total harmonic distortion in the range of frequencies 20 Hz to 20 KHz is within 1.5%.

The above objects are achieved by optimizing the structure of the micro loudspeaker and the design of the diaphragm.

### SUMMARY

The technical issue to be addressed by the present application is to propose a micro loudspeaker for in-ear headphones which has a distinctive double peak high sound pressure output frequency response at a high frequency range and a harmonic distortion within 1.5.

The following technical solution is proposed by the present application to solve the above technical problems. A micro loudspeaker is provided, which includes a frame with an open top, a T-yoke, a magnet, a washer, a diaphragm, a voice coil, a protective cap, and a circuit board. The T-yoke is installed in the frame, and the magnet is ring-shaped and sleeved on the T-yoke, the washer is connected to the top of the magnet, and a ring-shaped gap is formed between inner walls of the magnet and the washer and an outer wall of a center pole of the T-yoke for the voice coil to move up and down. A ring-shaped step for connecting the diaphragm is formed on an inner wall of the frame and above the washer, and a height difference between the ring-shaped step and the washer ranges from 0.1 mm to 0.8 mm, and the bottom of an edge of the diaphragm is connected to a top surface of the ring-shaped step. The protective cap is placed over the diaphragm, and is provided with a through hole having a diameter ranging from 1 mm to 3 mm at the center thereof.

Further, the diaphragm is composed of a dome portion and a corrugated rim portion connected to the dome portion in a circumferential direction of the dome portion, the top of the voice coil is connected to the bottom of the diaphragm, and profiles of cross sections of the dome portion and the corrugated rim portion are each a multi-segment arc.

Further, the top of the voice coil is connected to the bottom of a joint between the dome portion and the corrugated rim portion.

Further, the diaphragm is composed of a polyarylate (PAR) material layer and a polyurethane (PU) material layer, and a top surface of the diaphragm is coated with a metallic titanium coating.

Further, the voice coil is made by coiling an enameled copper clad aluminum wire.

Further, a vent hole is provided at the bottom of the frame, and a tuning mesh cloth is arranged on the vent hole.

Further, a copper ring is provided at an edge of the corrugated rim portion, and an edge of the protective cap is pressed onto the copper ring.

The beneficial effects of the present application are as follows.

Through optimizing the structure of the micro loudspeaker and the design of the diaphragm, the micro loudspeaker according to the present application meets the special requirements of in-ear headphones on the frequency response upon the micro loudspeaker output and also has a distinctive double peak high sound pressure output frequency response at a high frequency range, and in addition, its harmonic distortion is within 1.5.

### BRIEF DESCRIPTION OF THE DRAWINGS

A micro loudspeaker according to the present application is further described below with reference to the drawings.

FIG. 1 is a schematic view showing the structure of the micro loudspeaker according to the present application;

FIG. 2 is a schematic view showing the structure of a diaphragm;

FIG. 3 is a diagram showing a frequency response curve of the micro loudspeaker according to the present application; and

FIG. 4 is a diagram showing a harmonic distortion curve of the micro loudspeaker according to the present application.

### DETAILED DESCRIPTION

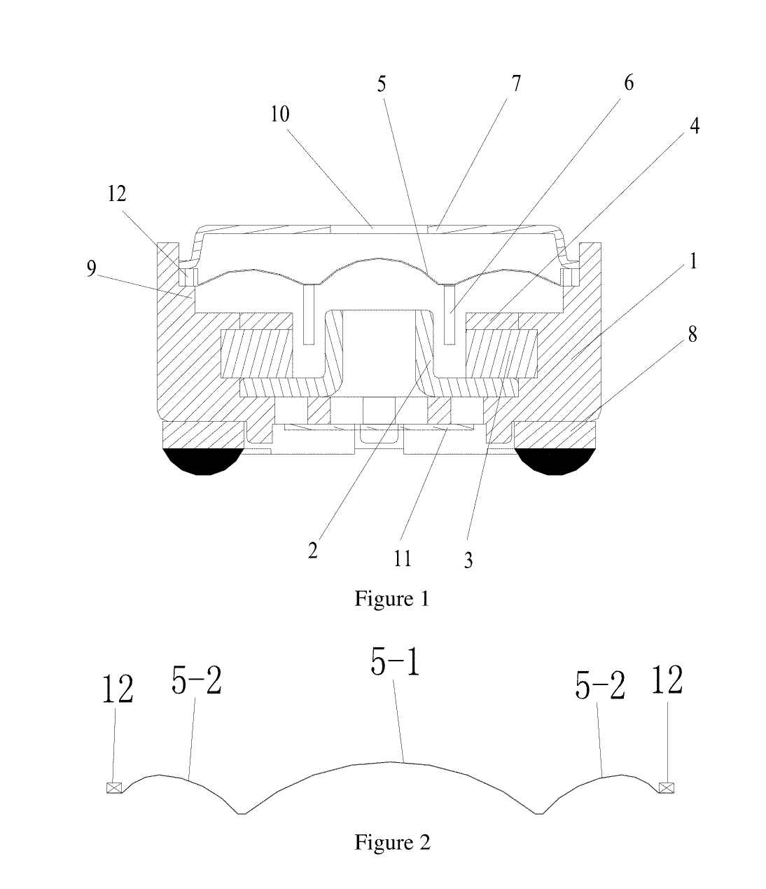

As shown in FIGS. 1 and 2, the micro loudspeaker according to the present application includes a frame 1 with an open top, a T-yoke 2, a magnet 3, a washer 4, a diaphragm 5, a voice coil 6, a protective cap 7, and a circuit board 8.

The T-yoke 2 is installed in the frame 1, the magnet 3 is ring-shaped and sleeved on the T-yoke 2. The washer 4 is connected to the top of the magnet 3, and a ring-shaped gap is formed between inner walls of the magnet 3 and the washer 4 and an outer wall of a center pole of the T-yoke 2 for the voice coil 6 to move up and down.

The diaphragm 5 is composed of a dome portion 5-1 and a corrugated rim portion 5-2 connected to the dome portion 5-1 in a circumferential direction of the dome portion 5-1, but of course diaphragms of other structural forms may also be used.

The voice coil 6 is made by coiling an enameled copper clad aluminum wire, and the top of the voice coil 6 is connected to the bottom of the diaphragm 5.

Profiles of cross sections of the dome portion 5-1 and the corrugated rim portion 5-2 are each a multi-segment arc. Preferably, the multi-segment arc is a three-segment arc, and the diaphragm 5 may further be provided with a ring-shaped array of reinforcing ribs.

A ring-shaped step 9 for connecting the diaphragm 5 is formed on an inner wall of the frame 1 and above the washer 4, and a height difference between the ring-shaped step 9 and the washer 4 ranges from 0.1 mm to 0.8 mm.

When to connect, the bottom of an edge of the corrugated rim 5-2 is connected to a top surface of the ring-shaped step 9.

The protective cap 7 is placed over the diaphragm 5 and is provided with a through hole 10 having a diameter ranging from 1 mm to 3 mm at the center opposite to the dome 5-1.

A vent hole is provided at the bottom of the frame 1, and a tuning mesh cloth 11 is arranged on the vent hole.

The diaphragm 5 is a composed of a PAR (Polyarylate) material layer and a PU (polyurethane) material layer, and a top surface of the diaphragm 5 is coated with a metallic titanium coating.

The top of the voice coil 6 is connected to the bottom of a joint between the dome portion 5-1 and the corrugated rim portion 5-2.

A copper ring 12 is provided at an edge of the corrugated rim portion 5-2, and an edge of the protective cap 7 is pressed onto the copper ring 12.

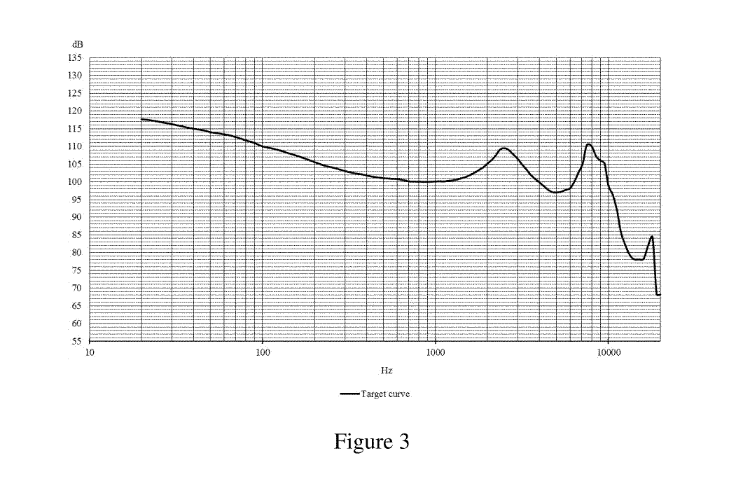

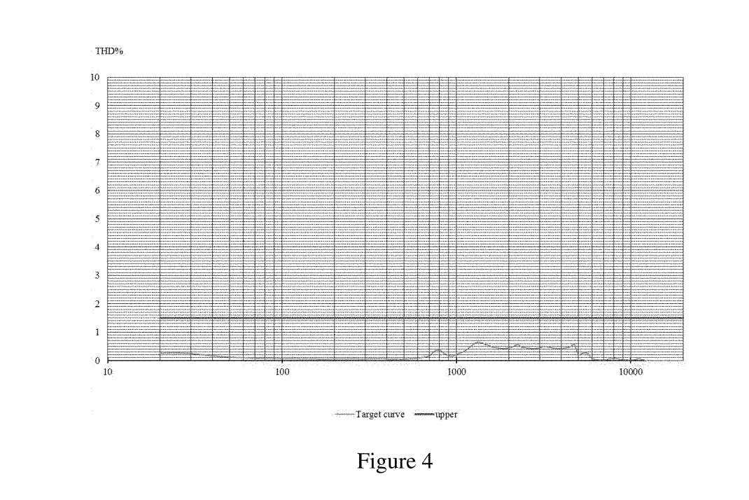

As shown in FIGS. 3 and 4, from the perspective of the test data, the loudspeaker according to the present application achieves output of double-peak high sound pressure at a high frequency range and also ensures that the harmonic distortion is within 1.5.

The present application is not limited to the above embodiments. The technical solutions of the above embodiments of the present application may be combined with each other to form a new technical solution. In addition, technical solutions formed by equivalent substitutions all fall into the scope of protection claimed by the present application.

1. A micro loudspeaker, comprising a frame with an open top, a T-yoke, a magnet, a washer, a diaphragm, a voice coil, a protective cap, and a circuit board, wherein the T-yoke is installed in the frame, and the magnet is ring-shaped and sleeved on the T-yoke, the washer is connected to the top of the magnet, and a ring-shaped gap is formed between inner walls of the magnet and the washer and an outer wall of a center pole of the T-yoke for the voice coil to move up and down, wherein,
a ring-shaped step for connecting the diaphragm is formed on an inner wall of the frame and above the washer, and a height difference between the ring-shaped step and the washer ranges from 0.1 mm to 0.8 mm, and the bottom of an edge of the diaphragm is connected to a top surface of the ring-shaped step; and
the protective cap is placed over the diaphragm, and is provided with a through hole having a diameter ranging from 1 mm to 3 mm at the center of the protective cap.

2. The micro loudspeaker according to claim 1, wherein the diaphragm is composed of a dome portion and a corrugated rim portion connected to the dome portion in a circumferential direction of the dome portion, the top of the voice coil is connected to the bottom of the diaphragm, and profiles of cross sections of the dome portion and the corrugated rim portion are each a multi-segment arc.

3. The micro loudspeaker according to claim 2, wherein the top of the voice coil is connected to the bottom of a joint between the dome portion and the corrugated rim portion.

4. The micro loudspeaker according to claim 1, wherein the diaphragm is composed of a polyarylate material layer and a polyurethane material layer, and a top surface of the diaphragm is coated with a metallic titanium coating.

5. The micro loudspeaker according to claim 1, wherein the voice coil is made by coiling an enameled copper clad aluminum wire.

6. The micro loudspeaker according to claim 1, wherein a vent hole is provided at the bottom of the frame, and a tuning mesh cloth is arranged on the vent hole.

7. The micro loudspeaker according to claim 2, wherein a copper ring is provided at an edge of the corrugated rim portion, and an edge of the protective cap is pressed onto the copper ring.
